(19) United States
(12) Patent Application Publication
(10) Pub. No.: US 2019/0035297 A1
(43) Pub. Date: Jan. 31, 2019

(54) Integrated Employee Training and Performance Evaluation System

(71) Applicant: Alchemy Systems, L.P., Austin, TX (US)

(72) Inventors: Archie D. Barrett, Georgetown, TX (US); Paul Chamberlain, Pflugerville, TX (US); Andrew L. Galindo, Austin, TX (US); Jason R. Moore, Cedar Park, TX (US); Jennifer Bacon, Austin, TX (US)

(73) Assignee: Alchemy Systems, L.P., Austin, TX (US)

(21) Appl. No.: 15/997,691

(22) Filed: Jun. 4, 2018

Related U.S. Application Data
(63) Continuation-in-part of application No. 14/639,030, filed on Mar. 4, 2015, now abandoned.
(60) Provisional application No. 61/947,943, filed on Mar. 4, 2014.

(51) Int. Cl. G09B 7/08; G09B 19/00

(52) U.S. Cl. CPC G09B 7/08; G09B 19/00

(57) ABSTRACT

A method for integrating employee training management with on-the-job employee performance evaluation, whereby one or more specified training courses are completed by one or more employees. One or more observations are automatically assigned to the one or more employees. The assignments are completed by one or more supervisors. In a system for performing same, a processor is operatively coupled to a memory device configured for storing program code which, when executed by the processor, causes the processor to perform steps of receiving notifications when one or more specified training courses is completed by one or more employees; automatically assigning one or more observations to the one or more employees; and receiving notifications when the assignments are completed by one or more supervisors.

### CROSS-REFERENCE TO RELATED APPLICATIONS

This application is a continuation-in-part of U.S. application Ser. No. 14/639,030 filed Mar. 4, 2015, which claimed the benefit of U.S. Provisional Application No. 61/947,943, filed Mar. 4, 2014, which applications are hereby incorporated herein by reference, in their entirety.

### TECHNICAL FIELD

The invention relates generally to employee training and performance evaluation and, more particularly, to a system for integrating employee training management with on-the-job employee performance evaluation.

### BACKGROUND

One of the challenges with professional training and teaching is finding effective ways to reinforce what was taught and learned, and verifying that employees are actually doing in the workplace what they have been trained to do. Training companies traditionally either ignore the problem or rely on test questions to verify that employees learned the material. However, while tests effectively measure what employees have learned, they are less effective in evaluating how well employees retain, and more importantly, implement, the knowledge they learned while performing their jobs.

To better evaluate how well employees retain and implement what they have been taught, companies have conducted internal and external audits, observations, and checklists as important parts of processes and standard operating procedures. Typically these activities are done with paper, pen and a clipboard. In recent years companies have provided audit systems for industrial settings to automate the collection and processing of audit, observation, and checklist information. These automatic systems generally fall into two categories: (1) stand-alone audit systems; and (2) audit systems that are integrated with a safety management system or a quality management system or a similar system. The problem with these systems is that the audits are not automatically integrated with the organization's training and learning activities. In the case of the safety management systems and quality management systems, the audits are part of the organizations facility safety or product quality activities, and not part of the training and learning system.

Therefore, what is needed is a way to integrate audits and observations into a training and learning system, to thereby provide a fully automated system to verify that, while working, employees are doing what they have been trained to do, and if they are deficient, to automatically remediate with more training and learning in a closed loop process.

### SUMMARY

Accordingly, the present invention includes a computer assisted observation system that allows supervisors and the like to use devices such as tablets (e.g., an iPad or the like) to enter information regarding the work abilities of specific employees. One preferred embodiment of the invention entails a process that begins with providing computer-based or instructor-led training and learning to one or more employees. The training is delivered and/or managed by a cloud-based system, also referred to herein as SISTEM Manager® or simply “Manager”. After an employee successfully completes training, Manager automatically assigns them an observation to be carried out by their supervisor while they are working. The purpose of the observation is to verify that the employee is doing what he has just been successfully trained to do. The observation is automatically downloaded from Manager to an app referred to herein as “SISTEM Coach” or simply “Coach”, which app is preferably loaded on a tablet, such as an iPad®, utilized by the supervisor. In addition, corrective action information is downloaded with the observation. If the employee does not pass the observation, the supervisor carries out the steps identified in the corrective action. Completed observation information is also transmitted from Coach back to Manager. In the case where the employee fails the observation, additional training is automatically assigned to the employee by Manager to reinforce the learning objectives. This process of training followed by an observation is repeated until the employee consistently demonstrates mastery of both knowing the training material and doing in the work environment what was taught. If the employee passes the first observation the information is transmitted from Coach to Manager, and the employee is often re-assigned the same observation on multiple occasions in the future to ensure that they continue to do what they have been trained to do.

Coach also allows the supervisor to carry out ad-hoc observations, that is, an observation that is not assigned but that the supervisor believes is important to carry out.

Furthermore, the corrective actions may include on-the-job training by the supervisor, or assigned training delivered immediately on a tablet, or other intervention instructions to the supervisor to immediately address the situation.

In summary, the purpose of Coach is to observe employees while they are performing their job and: (1) verify that employees are following production guidelines and/or doing what they have been trained to do; (2) prompt supervisors to give on-the-job/on-the-production floor immediate remediation training to correct any non-conformances that are observed or correct the problem using a different approach; (3) document the on-the-job production training; (4) document all other aspects of this activity; and/or (5) automate the whole process.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a high-level conceptual block diagram illustrating a system embodying features of the present invention;

FIG. 2 depicts a flow chart illustrating control logic embodying features of the present invention for integrating employee training management with on-the-job employee performance evaluation;

FIG. 3 exemplifies an overview and data flow of the present invention; and

FIG. 4 depicts a flow chart illustrating a further embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

It is noted that, unless indicated otherwise, all functions described herein may be performed by a processor such as a microprocessor, a controller, a microcontroller, an application-specific integrated circuit (ASIC), an electronic data processor, a computer, or the like, in accordance with code, such as program code, software, integrated circuits, and/or the like that are coded to perform such functions. Furthermore, it is considered that the design, development, and implementation details of all such code would be apparent to a person having ordinary skill in the art based upon a review of the present description of the invention.

For definitional purposes, the term “observation” and variations such as “observe” will be used substantially synonymously and interchangeably with the terms “performance evaluation”, “audit”, “inspection”, and “checklist” to describe what supervisors in a factory and/or manufacturing plant do to check and make sure that employees are following production guidelines, and doing what they have been trained to do. The term “employee” will be used substantially synonymously and interchangeably herein with the terms “trainee” to refer to anyone who receives training to perform a specified function or task, the effectiveness of which training would be desirable to observe or evaluate. Further, as used herein, the term “substantially” is to be construed as a term of approximation.

An app referred to herein as “SISTEM Coach”, or simply “Coach”, is the first system to fully integrate an audit/observation system with a training management system as taught in U.S. patent application Ser. No. 11/851,777 filed Sep. 7, 2007, to Dhillon et al. and U.S. patent application Ser. No. 13/055,423 filed Jan. 21, 2011, to Manser et al., both of which are abandoned, and both of which are incorporated herein by reference in their entirety. Such integration provides the best way to verify that a workforce is doing what it has been trained to do on a broad scale. This has resulted in a number of unique solutions that are the subject of this patent application. In accordance with principles of the invention, if an employee fails an observation or part of an observation, then the employee is automatically assigned to take some sort of developmental remediation as the corrective action. This remediation can be on the job/instructor-led training, or it could be a new course to take, or the same course to re-take, or material to read and study, etc. The combination of one or more courses, followed by one or more observations, followed by one or more remediation activities is grouped together as a Learning Plan within the Learning Management System (“LMS”). This cycle of teaching followed by an on the job observation, followed by the right amount of remedial teaching, followed by another observation, is a closed-loop cycle of learning that produces great results in terms of aligning employee behavior with organizational goals. Upon completion of the remediation activities, and subsequent learning activities, the employee is observed to ensure that s/he is performing his work activities as s/he has been taught in the course.

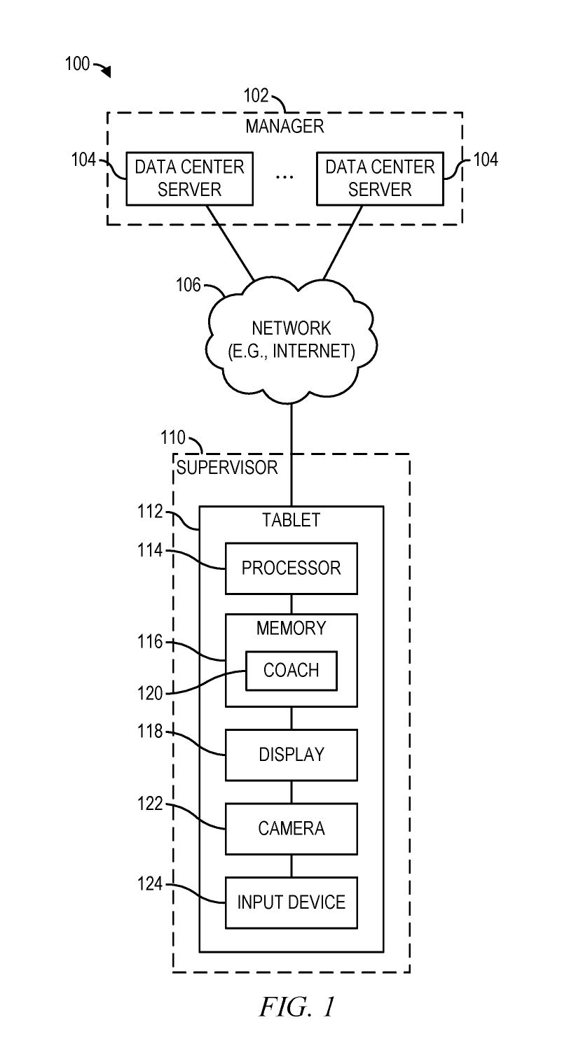

Referring to FIG. 1, one preferred embodiment of the present invention 100 includes: 1) standard components in commercially available LMSs such as SISTEM Manager (“Manager”) 102, including data center servers 104; 2) non-standard components in the LMS, discussed below; 3) a tablet 112; and 4) data communication 106 between the LMS 102 and tablet 112. Tablet 112 preferably includes a processor 114, a non-transitory computer readable medium referred to as a memory 116 coupled to the processor and configured for storing a tablet application 120, referred to herein as Coach, and executable by processor 114. Tablet 112 further preferably includes a display 118, a camera 122, and an input device 124, such as a keyboard, a mouse and/or the like. Tablet 112 components are overseen by a supervisor 110.

Standard LMS components required for the preferred embodiment include the following capabilities: 1) manage employee accounts and activity records (for example training records); 2) create or install a training course; 3) assign the course to one or a specific group of employees; 4) employees have a way of taking the course; 5) the system either automatically records and/or allows manual input and tracks the employees results in taking the course including the score, date, pass/fail, etc. in the LMS database; 6) a learning plan structure that allows learning leaders to group courses and assign follow-up actions after courses are completed; 7) a reporting system that allows supervisors and/or leaders to obtain information on organizational training performance from the employee data.

Non-standard LMS components required in the preferred embodiment include the following capabilities: 1) create an observation; 2) assign the observation as a part of a learning plan; 3) assign the observation to an employee or a specific group of employees as a follow-up action item after completing one or more courses; 4) create a follow-up action (corrective action) requirement that provides the next steps after the observation is complete; 5) the system either automatically records and/or allows manual data input and tracks the employees observation results including the score, date, pass/fail, pictures, notes, signatures, etc. in the LMS database; 5) a reporting system that allows supervisors and/or learning leaders to obtain information on individual and group performance on observations, in addition to corrective actions completed and outstanding, and root cause analysis; 6) an administrative role that identifies an employee as an Observer (only these Observers can carry out observations on the tablet device).

An observation is similar to a course test, and a test engine may be leveraged and repurposed to create an observation engine. Observations comprise questions, answers and an outcome that is typically a score and a pass or fail status. Typically observations also include some or all of the following: supervisor notes, pictures, signatures, corrective actions, root cause analysis, time and date stamp, and the person that conducted the observation. Typical observation question types include the following: 1) yes/no; 2) yes/no/not applicable; 3) compliant/not compliant/partially compliant/not applicable; 4) safe/at risk; 5) scaled score: 1, 2, 3, 4, etc., where the observer grades how well an employee carried out an activity.

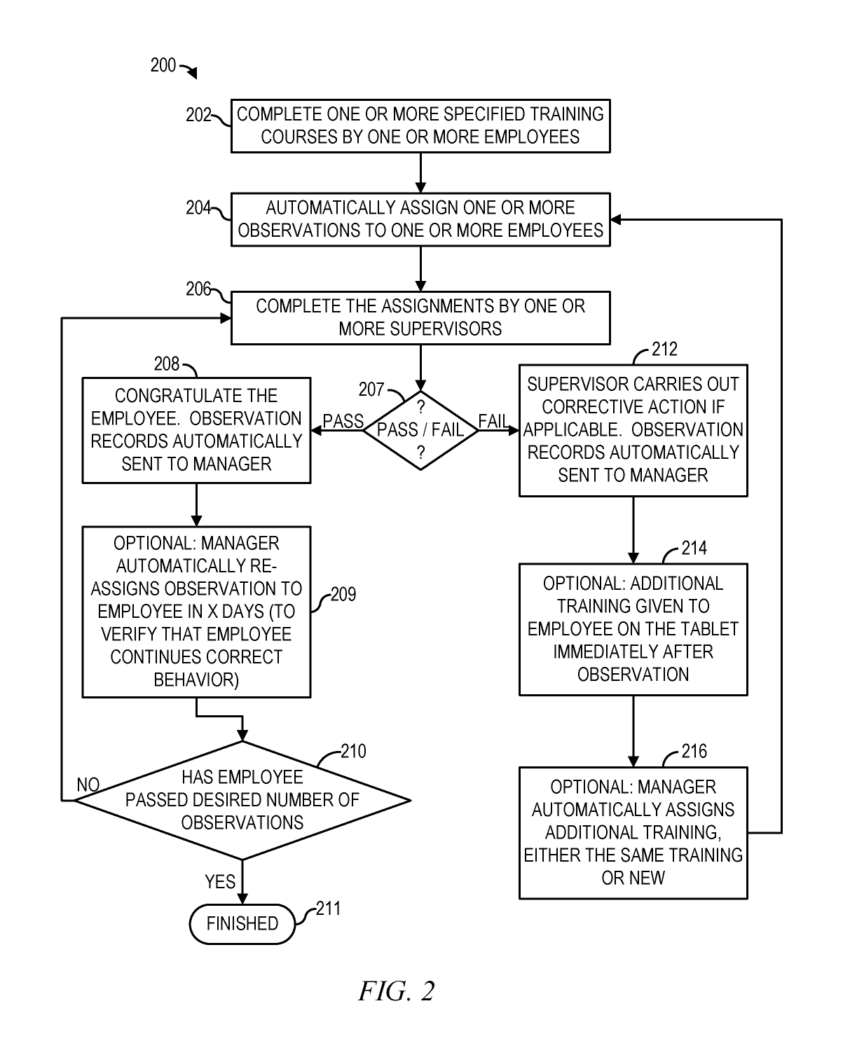

With reference to FIG. 2, Coach is a computer-assisted observation system that allows supervisors to use an electronic tablet, such as an iPad, to carry out observations on specific employees. In the typical embodiment Coach is initially configured to identify the company and the facility where the app will be used. After the configuration, Coach preferably synchronizes (syncs) with a cloud-based system, also referred to herein as “SISTEM Manager” or simply “Manager”, to download and display observation assignments (i.e., specific observations to be conducted of specific employees) for employees that work at the selected facility. Employees designated as Observers at the facility are also downloaded and stored in the tablet memory, Only these Observers are able to log into the Coach app (using the same credentials as they use with Manager). At 202 and 204, after logging in, Observers can carry out the observation assignments for either all personnel at the facility or only those that report to the Observer. Observers can also carry out observations on an ad-hoc basis on any employee that they supervise. During synchronization of the Coach app, at 206 completed observation data (including answers to questions, comments, pictures, root cause analysis, and signatures) is also uploaded to the Manager, and this information is stored, analyzed, reported on, and further treated as desired. At 212, Coach observation may include recommended corrective actions so that when an employee does not perform part of their job correctly (i.e., fails an observation), the supervisor has instructions on what to do to correct the situation. The correction might be at 214 to immediately pull the employee off a production line (or other type of work area) and train them on the correct way to do the task. Or at 216, it might be to schedule a meeting or computer-based training at a later date. Another, and often preferred, path after a failed observation, is for Manager to automatically assign new training to the employee, perhaps repeating the same course or taking a new remedial course covering the same learning objectives. Alternatively, the corrective action may be to start a follow-up remediation course for the employee to take immediately in the work area using the tablet device.

If the employee passes the observation at 207, then the employee is preferably congratulated at 208, and at 209 the preferred implementation assigns the same observation to the employee two or three more times with an interval between each observation. This ensures that the employee continues to follow the desired behavior. At 210, if the employee passes the desired number of observations, then that training is completed; otherwise, the process returns to 206.

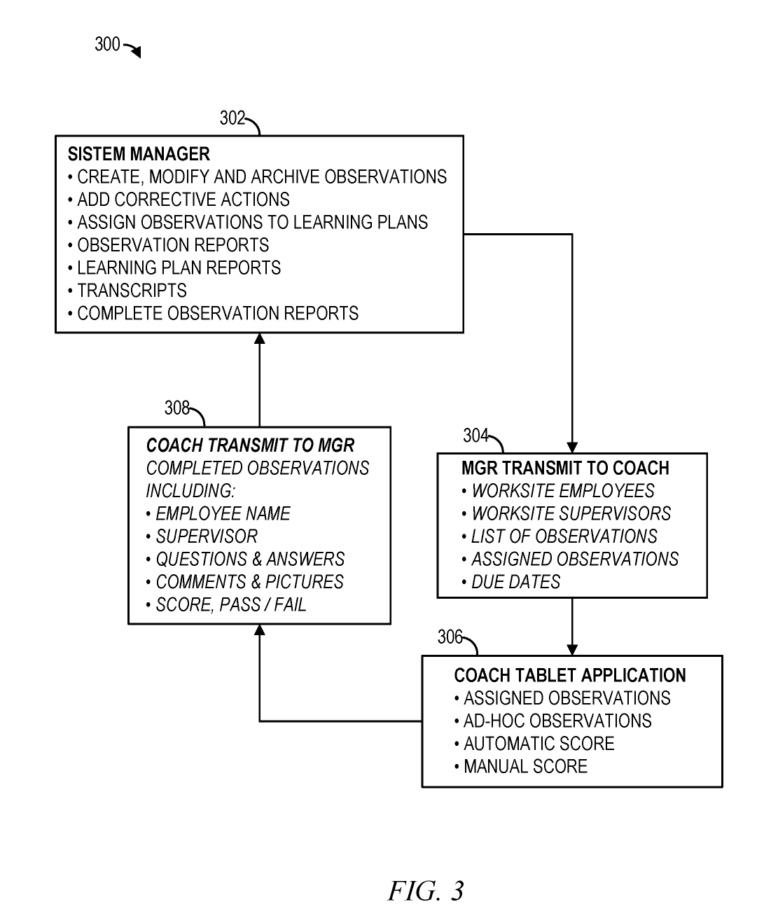

With reference to FIG. 3, and from a high level, the data flow between Manager and Coach occurs as follows. Manager 302 sends the following information 304 to Coach 306: employee names and IDs, authorized observer information, a list of available ad-hoc observations, a list of assigned observations, and due dates (where applicable). After completing observations, Coach 306 sends all of the data 308 corresponding to the completed observation to Manager for storage, analysis, reporting, and processing: such data 308 including, but not limited to, questions and answers, comments and pictures, employee name and ID, supervisor name and ID, the score and/or the pass/fail grade, and optionally the digital signatures of the observer and the employee.

With the preferred embodiment, observers first synchronize the Coach tablet application with Manager using an Internet connection, and then work off-line (i.e., no Internet connection required) for an indefinite period of time while carrying out observations in the work area. Periodically the observers should synchronize the Coach application to send completed observation data up to Manager, and receive new employee information (e.g., new hires, terminations), new observations and new observation assignments on the Coach application. The ability to work offline is important in many work environments such as manufacturing and retail where Internet connection can be difficult to obtain in many parts of the working environment.

The Internet communication between Coach and Manager preferably uses industry standard web services interfaces such as SOAP or a REST API.

In an alternative embodiment, Coach capabilities may be embedded inside of Manager. Instead of data being sent back and forth between Coach and Manager across a network, the Coach function would simply store and retrieve data directly to/from the Manager database.

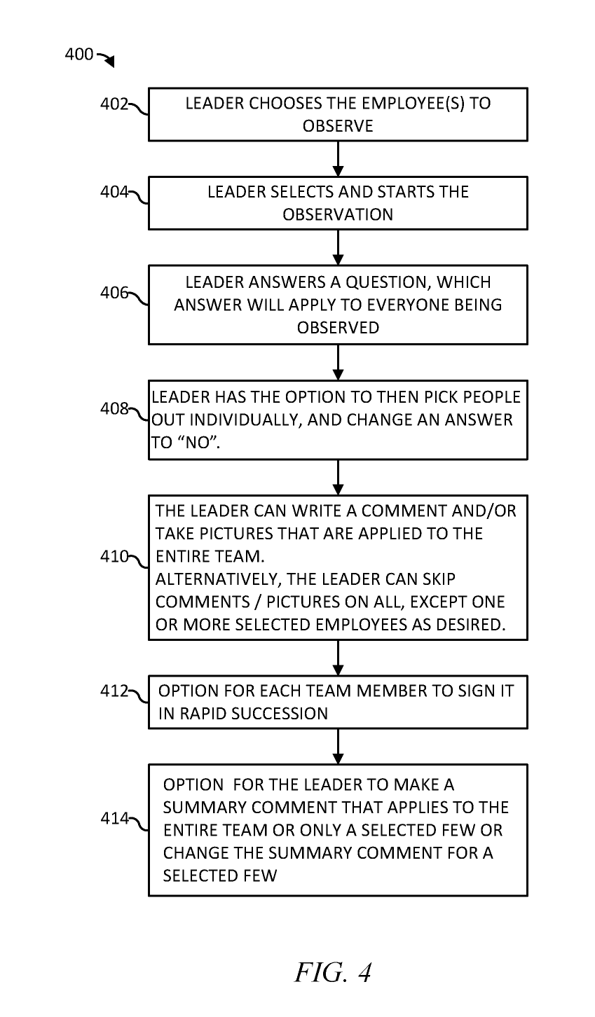

In a still further preferred embodiment, with reference to FIG. 4, step 402 of flow chart 400, a supervisor, referred to herein as a “leader”, chooses the employee s/he wants to observe; for example, a leader may choose everyone with the same assigned observation on a specific team.

At step 404, the leader selects and starts an observation.

At step 406, the leader answers a question, which answer will preferably apply to everyone being observed. For example: is the employee wearing hair nets properly. Answer, “yes” may apply to all people on the team.

At step 408, leader has the option to then pick people out individually, and change an answer to “no”.

At step 410, similarly, the leader can write a comment and/or take pictures that are applied to the entire team, and then selectively change the comment and/or pictures for specific individuals. Alternatively, the leader can skip comments/pictures on all, except one or more selected employees as desired.

At step 412, after completing the observation, there is an option for each team member to sign it in rapid succession.

At step 414, there is also an option for the leader to make a summary comment that applies to the entire team or only a selected few or change the summary comment for a selected few. In this way the leader can rapidly complete the observation for the entire team.

This process significantly speeds up the process for observing a group of people on the same observation. It saves the leader a lot of time, allowing them to focus on other things.

The ability to observe multiple workers at the same time with the same observation has much value. For example, it significantly decreases the time it takes to observe workers. This embodiment of FIG. 4 enables leaders to identify, say ten workers, pick one observation, and carry out that observation on all ten workers at once.

It is understood that the present invention may take many forms and embodiments. Accordingly, several variations may be made in the foregoing without departing from the spirit or the scope of the invention. For example, in one embodiment corrective actions or an automatic response after a passed or failed observation may be eliminated. In another embodiment, supervisors may be prompted to assign a specific observation after training, but not automatically assign it. In yet, another embodiment, Manager may be run on a network, such as a local area network (LAN), and/or Coach may be run on a laptop computer, smart phone, or some device other than a tablet. In a still further embodiment, Manager and Coach may be incorporated into the same app, so that Manager is not in the cloud, but actually part of the Coach app.

In further variations, a supervisor is permitted to take pictures and videos as artifacts for an observation. A photo preferably includes annotation options. A user is preferably permitted to sign name with a finger on the tablet to capture digital signatures for the observation. A tablet preferably supports foreign character sets, and switching from one language to another.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

What is claimed is:

1. A method for electronically integrating training management with performance evaluation, comprising:
determining if two or more employees have completed one or more specified training courses;
upon a determination that the one or more specified training courses have been completed by the two or more employees, automatically assigning and downloading by a processor via a network from at least one of two or more cloud-based data center servers one or more observations and corrective action information;
executing one of the one or more observations;
determining if the two or more employees have passed the one of the one or more observations;
upon a determination that the two or more employees have passed the one of the one or more observations, transmitting from the processor information indicative of same to the at least one of the two or more cloud-based data center servers; and
upon a determination that the two or more employees have not passed the one of the one or more observations, providing additional training identified in corrective action information.

2. The method of claim 1 wherein the processor is a hand-held device.

3. The method of claim 1 wherein the additional training identified in the corrective action information further comprises completing assignments using a hand-held device, the hand-held device being an iPad®.

4. The method of claim 1 wherein determining if the one or more specified training courses have been completed further comprises determining if the one or more specified training courses have been completed within a predetermined time period.

5. The method of claim 1 wherein additional training identified in the corrective action information further comprises completing assignments within a predetermined time period.

6. The method of claim 1 further comprising repeating the additional training identified in the corrective action information.

7. The method of claim 1 further comprising:
determining whether the two or more employees have failed the one of the one or more observations; and
automatically assigning one or more additional training courses, after a determination has been made that the one or more observations has been failed.

8. The method of claim 1 further comprising:
determining whether the two or more employees have failed a question of the one of the one or more observations; and
automatically assigning a training course, after a determination has been made that the two or more employees have failed the question of the one of the one or more observations.

9. The method of claim 1 further comprising:
determining whether the two or more employees have failed the one of the one or more observations; and
automatically providing instructions on how to train on a production floor to remediate a failure, after a determination has been made that the two or more employees have failed the one of the one or more observations.

10. The method of claim 1 further comprising:
determining whether the two or more employees have failed the question of the one of the one or more observations; and
automatically providing instructions on how to train on a production floor to remediate the question, after a determination has been made that the two or more employees have failed the question of the one of the one or more observations.

11. The method of claim 1 further comprising:
determining whether the two or more employees have passed the one of the one or more observations; and
automatically assigning one or more additional training courses, after a determination has been made that the two or more employees have passed the one of the one or more observations.

12. The method of claim 1 wherein the additional training identified in the corrective action information further comprises providing additional training identified in the corrective action information on a hand-held device, and the method further comprising:
determining whether the two or more employees have passed the one of the one or more observations; and
automatically assigning one or more additional training courses using the hand-held device, after a determination has been made that the two or more employees have passed the one of the one or more observations.

13. The method of claim 1 wherein additional training identified in the corrective action information further comprises providing additional training identified in the corrective action information on a hand-held device, and the method further comprising:
determining whether a question of the two or more employees have failed the one of the one or more observations; and
automatically providing instructions on how to train on a production floor, using the hand-held device, to remediate the question, after a determination has been made that the two or more employees have failed the one of the one or more observations, thereby enabling training following the one of the one or more observations to address needs.

14. The method of claim 1 further comprising recording whether a determination has been made that the two or more employees have completed the one or more specified training courses, an assignment of the one or more observations, and completion of the assignments.

15. The method of claim 1 further comprising a camera coupled to the processor, and the method further comprises generating with the camera pictures of selected aspects of the one or more observations.

16. A system for integrating training with performance evaluation, the system comprising:
a network;
two or more cloud-based data center servers connected to the network;
a processor connected to at least one of the two or more cloud-based data center servers via the network; and
a non-transitory memory device operably coupled to the processor, the non-transitory memory device being configured for storing program code which, when executed by the processor, causes the processor to perform steps of:
triggering follow-up actions when two or more employees complete one or more specified training courses;
automatically assigning one or more observations when the two or more employees complete the one or more specified training courses; and
receiving first notifications when the one or more observations are completed.

17. The system of claim 16 further comprising a camera coupled to the processor for generating pictures of selected aspects of the one or more observations.

18. The system of claim 16 wherein the step of receiving the first notifications when the assignments are completed further comprises receiving second notifications when the assignments are completed using a hand-held device.

19. The system of claim 16 wherein the step of receiving the first notifications when the assignments are completed further comprises receiving second notifications when the assignments are completed using a hand-held device, the hand-held device being an iPad®.

20. The system of claim 16 wherein the step of receiving the first notifications when the one or more specified training courses are completed further comprises receiving second notifications when completing the one or more specified training courses within a predetermined time period.

21. The system of claim 16 wherein the step of receiving the first notifications when completing the assignments further comprises receiving second notifications when the assignments are completed within a predetermined time period.

22. The system of claim 16 wherein the program code, when executed by the processor, causes the processor to repeat the step of receiving the first notifications when the assignments are repeated.

23. The system of claim 16 wherein the program code, when executed by the processor, causes the processor to perform steps of:
receiving a second notification when the two or more employees have failed the one of the one or more observations; and
automatically assigning additional training courses, after a determination has been made that the two or more employees have failed the one of the one or more observations.

24. The system of claim 16 wherein the program code, when executed by the processor, causes the processor to perform steps of:
receiving a second notification when two or more employees have failed a question of the one of the one or more observations; and
automatically assigning a training course, after the second notification has been received indicating that the two or more employees have failed a question of the one of the one or more observations.

25. The system of claim 16 wherein the program code, when executed by the processor, causes the processor to perform steps of:
receiving a second notification when the two or more employees have failed a question of the one of the one or more observations; and
automatically providing instructions on how to train on a production floor, after the second notification has been received that the two or more employees have failed the question of the one of the one or more observations.

26. The system of claim 16 wherein the program code, when executed by the processor, causes the processor to perform steps of:
receiving a second notification when the two or more employees have failed a question of the one of the one or more observations; and
automatically providing instructions on how to train on a production floor to remediate the question, after the second notification has been received that the two or more employees have failed a question of the one of the one or more observations.

27. The system of claim 16 wherein the program code, when executed by the processor, causes the processor to perform steps of:
receiving a second notification when the two or more employees have passed the one of the one or more observations; and
automatically assigning one or more additional training courses, after the second notification has been received that the two or more employees have passed the one of the one or more observations.

28. The system of claim 16 wherein the step of completing the assignments further comprises completing the assignments on a hand-held device, and wherein the program code, when executed by the processor, causes the processor to perform steps of:
receiving a second notification when the two or more employees have passed the one of the one or more observations; and
automatically assigning one or more additional training courses using the hand-held device, after the second notification has been received that the two or more employees have passed the one of the one or more observations.

29. The system of claim 16 wherein the step of completing the assignments further comprises completing the assignments on a hand-held device, and wherein the program code, when executed by the processor, causes the processor to perform steps of:
receiving a second notification when the two or more employees have failed a question of the one of the one or more observations; and
automatically providing instructions on how to train on a production floor, using the hand-held device, to remediate the question, after the second notification has been received that the two or more employees have failed a question of the one of the one or more observations, thereby enabling training following the one or more observations to address needs.

30. The system of claim 16 further comprising wherein the program code, when executed by the processor, causes the processor to perform steps of:
recording completion of the one or more specified training courses by the two or more employees;
recording assignment of the one or more observations; and
recording completion of the assignments.

31. A system for integrating training management with performance evaluation, the system comprising:
a network;
two or more cloud-based data center servers connected to the network;
a processor connected to at least one of the two or more cloud-based data center servers via the network; and
a non-transitory computer readable medium embodying program code executable by the processor, the program code configuring the processor to:
receive first notifications when two or more employees have completed one or more specified training courses;
automatically assign one or more observations; and
receive second notifications when assignments are completed.

32. A method for integrating training management with performance evaluation, the method comprising steps performed by a computer processor executing program code for:
receiving, by the computer processor via a network from at least one of two or more cloud-based data center servers, first notifications when two or more employees have completed one or more specified training courses;
automatically assigning, by the computer processor, one or more observations; and
receiving, by the computer processor, second notifications when assignments are completed.
